(19) United States
(12) Patent Application Publication
(10) Pub. No.: US 2026/0032194 A1
(43) Pub. Date: Jan. 29, 2026

(54) IDENTIFYING NON-COMPLIANT COMMUNICATION SERVICES PLATFORM ACCOUNTS

(71) Applicant: Twilio Inc., San Francisco, CA (US)

(72) Inventors: Prateek Jain, San Francisco, CA (US); Priya Almeida, Renton, WA (US); Jeffrey Bergman, Westwood, NJ (US); Timothy Beyers, San Rafael, CA (US); Michael Carpenter, Port Angeles, WA (US); Akshit Dayal, Seattle, WA (US); Vijayaraghavan Jagannathan, Dublin, CA (US); Bhargav Kumar Guntamadugu, Lathrop, CA (US); Harshit Rastogi, Fremont, CA (US); Swapnil Bhanudas Sarode, San Francisco, CA (US); Yali Wu, San Francisco, CA (US)

(21) Appl. No.: 19/253,253

(22) Filed: Jun. 27, 2025

Related U.S. Application Data
(60) Provisional application No. 63/674,682, filed on Jul. 23, 2024.

(51) Int. Cl. H04M 3/436; H04M 3/22

(52) U.S. Cl. CPC H04M 3/4365; H04M 3/2281

(57) ABSTRACT

A method for identifying accounts used to make noncompliant calls (e.g., robocalls or voice spam calls) includes obtaining, by a communication services platform, one or more metrics for voice calls associated with a first identifier of a first communication endpoint. The one or more metrics include an average call duration for the first identifier or a predetermined signaling protocol code. The method includes determining, based on the metrics, a risk score associated with the first identifier. The method includes performing, based on the risk score, a corrective action with respect to an account of the communication services platform. The account can be associated with the first communication endpoint.

### RELATED APPLICATIONS

This application claims benefit of the U.S. Provisional Patent Application No. 63/674,682 filed Jul. 23, 2024, the contents of which are incorporated in their entirety by reference herein.

### TECHNICAL FIELD

Aspects and implementations of the disclosure relate to computer software, and more specifically, to systems and methods for identifying non-compliant communication services platform accounts.

### BACKGROUND

Entities can use communication services platforms to manage their communications, for example, via telephone calls or text messages. Sometimes, however, these entities can attempt to violate pertinent acceptable use policies, e.g., by placing robocalls (e.g., an automated phone call that uses a recording or artificial intelligence-generated voice to speak to an entity on the other end of the telephone call) or a voice spam call (e.g., an unwanted phone call).

### BRIEF DESCRIPTION OF THE DRAWINGS

Aspects and implementations of the disclosure will be understood more fully from the detailed description given below and from the accompanying drawings of various aspects and implementations of the disclosure, which, however, should not be taken to limit the disclosure to the specific aspects or implementations, but are for explanation and understanding.

FIG. 1 illustrates an example system architecture, in accordance with some implementations of the disclosure.

FIG. 2 illustrates an example flow of data for identifying non-compliant communication services platform accounts, in accordance with some implementations of the disclosure.

FIG. 3 depicts a flow diagram of an example method for identifying non-compliant communication services platform accounts, in accordance with some implementations of the disclosure.

FIG. 4 depicts a flow diagram of an example method for identifying non-compliant communication services platform accounts, in accordance with some implementations of the disclosure.

FIG. 5 is a block diagram illustrating an exemplary computer system, in accordance with some implementations of the disclosure.

### DETAILED DESCRIPTION

A communication services platform, such as a Software as a Service (SaaS) platform, can offer various communication services to users. For example, a SaaS platform can offer messaging service tools that facilitate messaging conversations, e.g., the sending and/or receiving of messages, such as short message service (SMS) messages, multimedia messaging service (MMS) messages, and/or instant messaging (IM) messages, to and from devices via various communication channels. The SaaS platform can offer voice call service tools that facilitate voice conversations, e.g., the making and receiving of voice calls using various protocols, such as Voice over Internet Protocol (VOIP), various mobile communications protocols, or Session Initiation Protocol (SIP).

Users of the communication services platform may attempt to violate pertinent acceptable use policies, e.g., by placing non-compliant voice calls (e.g., robocalls or unsolicited voice calls (“spam calls”)). “Robocall” generally refers to a call in which the caller uses a recording or artificial intelligence-generated voice to speak to the called party. The communication services platform may need to prevent non-compliant voice calls, for example, in order to comply with pertinent laws.

Aspects of the disclosure address the above-mentioned and other challenges by implementing systems and methods that identify accounts on a communication services platform that are used to make non-compliant voice calls and prevent the identified accounts from continuing to make such calls. An account on the communication services platform can utilize one or more communication endpoint identifiers (e.g., phone numbers) for initiating outgoing calls. The communication services platform can analyze metrics associated with communications originating from the communication endpoint. Based on the analysis, the communication services platform can determine whether the metrics indicate that the communication endpoint has been used to make non-compliant voice calls. The communication services platform can perform a mitigating or enforcing action on the account.

An example metric can reflect (i.e., can be determined by applying a predefined mathematical transformation to) an average duration of communications (e.g., voice calls) initiated using the communication endpoint associated with the identifier. Another example metric can reflect an answer-seizure ratio (ASR) for the communication endpoint (e.g., the number of calls placed by the communication endpoint that were answered by a receiving party divided by the total number of calls placed by the communication endpoint). Another example metric can reflect the number of calls that were initiated by the communication endpoint and produced a predetermined SIP code (e.g., a SIP code that indicates that the party receiving the call could not be found or declines to participate in the call). Another example metric can reflect an indication of the communication endpoint having communicated with another communication endpoint that is found on a do-not-call (DNC) list. Another example metric can reflect an indication of the communication endpoint having been used to communicate with a communication endpoint that is operated by a robocall surveillance system. Mitigating or enforcing actions can include suspending the user account associated with the identifier at issue, disabling use of the identifier in association with the platform, sending a notice to an owner of the user account, or other actions.

As noted, a technical problem addressed by implementations of the disclosure is detecting communication services platform accounts that are used to make non-compliant voice calls. A technical solution to the above-identified technical problem may include identifying potentially non-compliant accounts by utilizing voice call metrics for communications associated with identifiers non-compliant voice calls and taking mitigating or enforcement actions to prevent further non-compliant voice calls. Thus, a technical effect may include reducing the consumption of the platform's computing resources by non-compliant voice calls.

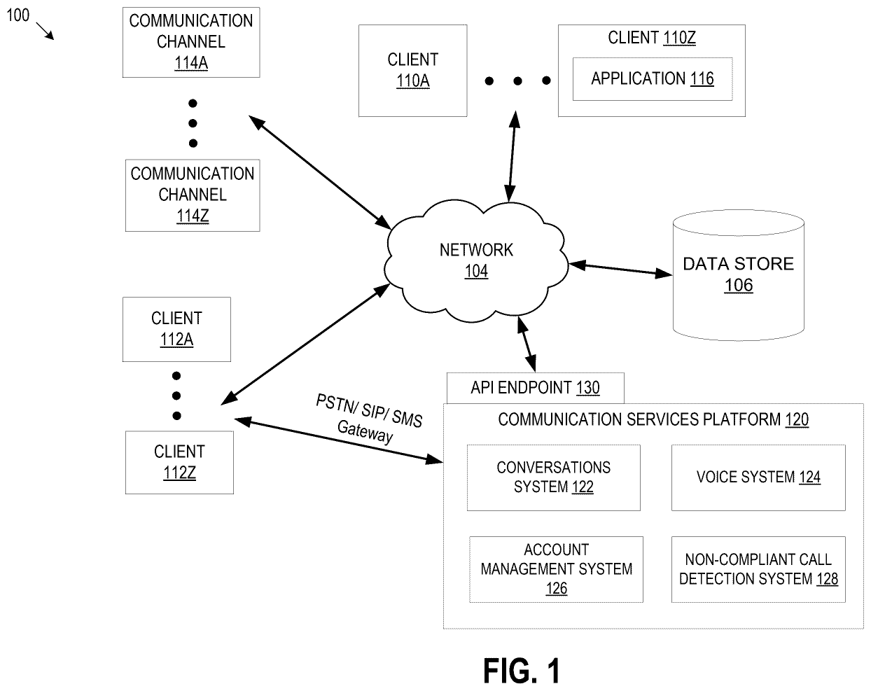

FIG. 1 illustrates an example system architecture 100, in accordance with some implementations of the disclosure. The system architecture 100 (also referred to as “system” herein) includes a communication services platform 120, a data store 106, one or more client devices 110A-110Z connected to a network 104, one or more client devices 112A-112Z communicatively coupled to the communication services platform 120, and one or more communication channels 114A-114Z coupled to the network 104 (or otherwise communicatively coupled to other elements of the system 100).

In some implementations, network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, the data store 106 is a persistent storage that is capable of storing data as well as data structures to tag, organize, and index the data. The data store 106 may be hosted by one or more storage devices, such as main memory, magnetic or optical storage-based disks, tapes or hard drives, network-attached storage (NAS), storage area network (SAN), and so forth. In some implementations, the data store 106 may be a network-attached file server, while in other implementations, the data store 106 may be some other type of persistent storage such as an object-oriented database, a relational database, and so forth, that may be hosted by communication services platform 120 or one or more different machines coupled to the communication services platform 120 via the network 104.

The client devices 110A-Z (generally referred to as “client device(s) 110” herein) may each include a type of computing device such as a desktop personal computer (PCs), laptop computer, mobile phone, tablet computer, netbook computer, wearable device (e.g., smart watch, smart glasses, etc.) network-connected television, smart appliance (e.g., video doorbell), any type of mobile device, etc. In some implementations, a client device 110 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components. In some implementations, the client devices 110A-Z may also be referred to as “user devices.”

In some implementations, a client device 110, such as the client device 110Z, can implement or include one or more applications, such as the application 116 (also referred to as “client application 116” herein) executed at the client device 110Z. In some implementations, the application 116 can be used to communicate (e.g., send and receive information) with communication services platform 120. In some implementations, application 116 can implement user interfaces (e.g., graphical user interfaces (GUIs)) that may be webpages rendered by a web browser and displayed on the client device 110Z in a web browser window. In another implementation, the user interfaces of the application 116 may be included in a stand-alone application downloaded to the client device 110Z and natively running on the client device 110Z (also referred to as a “native application” or “native client application” herein).

In some implementations, one or more client devices 110 can communicate with the communication services platform 120 using one or more function calls, such as application programming interface (API) function calls (also referred to as “API calls” herein). For example, the one or more function calls can be identified in a request using one or more application layer protocols, such a HyperText Transfer Protocol (HTTP) (or HTTP secure (HTTPS)), and that are sent to the communication services platform 120 from the client device 110Z implementing the application 116. In some implementations, the communication services platform 120 can respond to the requests from the client device 110Z by using one or more API responses using an application layer protocol. Similarly, communication services platform 120 can communicate with one or more communication channels 114A-114Z using API function calls.

In some implementations, one or more of client devices 110 can be identified by a uniform resource identifier (URI), such as a uniform resource locator (URL). For example, the communication services platform 120 can send an API call to the client device 110Z addressed to a URL specific to the client device 110Z. In some implementations, the communication services platform 120 can be identified by a URI. For instance, the API call sent by a client device 110 to the communication services platform 120 can be directed to the URL of the communication services platform 120.

In some implementations, the APIs used to access the conversations system 122 of the communication services platform 120 can be different from the APIs used to access the voice system 124 of the communication services platform 120. In some implementations, the APIs used by the application 116 executed on a desktop client device (e.g., desktop application) to access the voice system 124 can be different APIs than the APIs used by the application 116 executed on a mobile client device (e.g., mobile application) to access the voice system 124. In some implementations, the conversations system 122 and the voice system 124 can communicate between one another using APIs. In some implementations, the APIs used to communicate between the conversations system 122 and the voice system 124 may be private APIs that are not accessible by client devices 110 (or client devices 112).

In some implementations, client devices 112A-Z (generally referred to as “client device(s) 112” herein) may be similar to client devices 110. In some implementations, the client devices 112 can include one or more communication endpoints. A communication endpoint may include a device that a user can utilize to communicate with another communication endpoint. A communication endpoint may include a telephony device. A telephony device can include a Public Switched Telephone Network (PSTN)—connected device, such as a landline phone, cellular phone, or satellite phone, for example. In some implementations, a telephony device can also include an internet addressable voice device (e.g., non-PSTN telephony device), such as VoIP phones, or SIP devices, for example. In some implementations, a telephony device can include one or more messaging devices, such as a SMS network device that, for example, uses a cellular service to exchange SMS messages or MMS messages. A communication endpoint may include other types of devices. A communication endpoint can be identified by an identifier (e.g., a phone number, a network address, a universal resource identifier (URL), a numeric identifier, or an alphanumeric string).

In some implementations, the communication services platform 120 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components that may be used to provide a user with access to data or services. Such computing devices may be positioned in a single location or may be distributed among many different geographical locations. For example, the communication services platform 120 may include a plurality of computing devices that together may comprise a hosted computing resource, a grid computing resource or any other distributed computing arrangement. In some implementations, the communication services platform 120 may correspond to an elastic computing resource where the allotted capacity of processing, network, storage, or other computing-related resources may vary over time.

In some implementations, the communication services platform 120 provides one or more API endpoints 130 that can expose services, functionality or content of the communication services platform 120 to one or more of client devices 110 or communication channels 114A-114Z. In some implementations, an API endpoint 130 can be an endpoint of a communication channel in which the other endpoint can be implemented by another system, such as the client device 110Z or communication channel 114Z. In some implementations, the API endpoint 130 can include or be accessed using a resource locator, such a universal resource locator (URL), of a server or service. The API endpoint 130 can receive requests from other systems, and in some cases, return a response with information responsive to the request. In some implementations, HTTP or HTTPS methods can be used to communicate to and from API endpoint 130.

In some implementations, the API endpoint 130 (also referred to as a “request interface” herein) can function as a computer interface through which communication requests, such as message and/or voice requests, are received and/or created. The communication services platform 120 may include one or more types of API endpoints.

In some implementations, the API endpoint 130 can include a messaging API and/or voice API whereby external entities or systems can send a communication to create message content and/or request sending of a message and/or request voice services that are provided via voice system 124. The API (e.g., message API and/or voice API) may be used in programmatically creating message content and/or requesting sending of one or more messages and/or requesting the transfer or joining client device(s) to a voice call. In some implementations, the API is implemented in connection with a multitenant communication service wherein different accounts (e.g., authenticated entities) can submit independent requests. These requests made through the API can be managed with consideration of other requests made within an account and/or across multiple accounts on the communication service.

In some implementations, the API of the API endpoint 130 may be used in initiating general messaging or communication requests. For example, a messaging request may indicate one or more destination endpoints (e.g., as identified by recipient phone numbers), message content (e.g., text and/or media content), and possibly an origin endpoint (e.g., as identified by a phone number to use as the “sending” phone number).

In some implementations, the API of the API endpoint 130 may be any suitable type of API such as a Representational State Transfer (REST) API, a GraphQL API, a Simple Object Access Protocol (SOAP) API, and/or any suitable type of API. In some implementations, the communication services platform 120 can expose through the API, a set of API resources which when addressed may be used for requesting different actions, inspecting state or data, and/or otherwise interacting with the communication platform.

In some implementations, a REST API and/or another type of API may work according to an application layer request and response model. An application layer request and response model may use HTTP, Hypertext Transfer Protocol Secure (HTTPS), SPDY, or any suitable application layer protocol. Herein, HTTP-based protocol is described for purposes of illustration, the application layer may use other protocols. HTTP requests (or any suitable request communication) to the communication services platform 120 may observe the principles of a RESTful design or the protocol of the type of API. RESTful is understood in this document to describe a Representational State Transfer architecture. The RESTful HTTP requests may be stateless, thus each message communicated contains all necessary information for processing the request and generating a response. The API service can include various resources, which act as endpoints that can specify requested information or requesting particular actions. The resources can be expressed as URI's or resource paths. The RESTful API resources can additionally be responsive to different types of HTTP methods such as GET, PUT, POST and/or DELETE.

In some implementations, the API endpoint 130 can include a request instruction module that can be called within an application, script, or other computer instruction execution. For example, a computing platform may support the execution of a set of program instructions where at least one instruction within a script or other application logic is used in specifying a message request and communicating that request.

In some implementations, the API endpoint 130 can include a console, administrator interface, or other suitable type of user interface. Such a user-facing interface can be a graphical user interface. Such a user interface may additionally work in connection with a programmatic interface.

In some implementations, a request, such as a message request, can include a data object characterizing the properties of a message. In some implementations, the communication services platform 120 is associated with message requests that are programmatically initiated (e.g., an application-to-person (A2P) message). In some implementations, the message request could be one initiated from an inbound received message.

In some implementations, a request (e.g., message request and/or voice request) can include one or more of one or more destination endpoints, one or more origin endpoints, and message content and/or audio content. In some implementations, one or more of these properties may be specified indirectly such as through system or account configuration or identifier (e.g., messaging conversation identifier). For example, all messages may be automatically assigned an origin endpoint that is associated with an account. In some implementations, the message content can include any suitable type of media content including, text, audio, image data, video data, multimedia, interactive media, data, and/or any suitable type of message content.

In an illustrative example, communication services platform 120 can include a Software as a Service (SaaS) platform that can at least in part provide one or more services, such as communication services, to one or more clients. The SaaS platform may deploy services, such as software applications, to one or more clients for use as an on-demand service. For example, the SaaS platform may deliver and/or license software applications on a subscription basis while also hosting, at least in part, the software application. The licensed software applications can, at least in part, be hosted on the infrastructure, such as the cloud computing resources of the SaaS platform.

In some implementations, communication services platform 120, as noted above, can provide communication services that include, but are not limited to, voice services, messaging services (e.g., SMS services or MMS services), email services, video services, chat messaging services (e.g., internet-based chat messaging services), or a combination thereof. Communication operations using the communication services can use one or more of a communication network (e.g., Internet), telecommunications network (e.g., such as a cellular network, satellite communication network, or landline communication network), or a combination thereof, to transfer communication data between parties.

In some implementations, the voice system 124 of the communication services platform 120 can, via a client device 112, enable the placement of outbound voice calls from the client device 112 to another device that receives voice calls (which may be another client device 112 or another device capable of receiving voice calls). The voice system 124 may route inbound voice calls from another device to the client device 112. An outbound voice call can refer to a voice call from a client device 110 associated with an account (e.g., one or more of an organization's account or user account) of the communication services platform 120, and to another device that may not be associated with an account. An inbound voice call can refer to a voice call from a device that may not be associated with an account, and to a client device 110 associated with an account. It can be appreciated that a voice call between two client devices 110 that are associated with an account can be performed using communication services platform 120. Such voice calls can be considered inbound or outbound voice calls relative to the particular client device 110. The voice system 124 may generate metadata for voice calls placed or received using the voice system 124. The metadata for a voice call may include the identifier of the communication endpoint that received the voice call, the identifier of the communication endpoint that placed the voice call, the length of the call, whether the voice call was answered, signaling protocol codes associated with the voice call, or other voice call metadata. In some implementations, the voice system 124 may generate metrics based on the metadata.

In some implementations, voice system 124 can include one or more voice services used in conjunction with a voice call. In some implementations, the one or more voice services can include a transcription service that transcribes speech to text. In some implementations, the one or more voice services can include a recording service that can record the audio data of the voice call. In some implementations, the one or more voice services can include a voice call queue service that can queue inbound voice calls and release the queued voice call pursuant to user-defined logic. In some implementations, the one or more voice services can include voice mailbox services that store voice messages of at least inbound calls. In some implementations, the one or more voice services can include an interactive voice response (IVR) service that interacts with callers and gathers information for them by giving the callers choices via a menu, and then performs the actions based on the answers of the caller through the telephone keypad or through voice response. For example, the IVR service can allow a caller to interact with the back-end telephony system, such as voice system 124, by pressing keys that emit dual-tone multi-frequency (DTMF) signals or saying words that are processed by a speech recognition system. In some implementations, the one or more voice services can include conference call service that can connect three or more devices in a single call.

In some implementations, the communication services platform 120 can include a multitenant system. Multitenancy can refer to a mode of operation of software applications where multiple independent instances of one or multiple applications operate in a shared computer environment. In some implementations, the instances (tenants) can be logically isolated, but physically integrated. The degree of logical isolation can be complete, but the degree of physical integration can vary. The tenants (application instances) can be representations of organizations that obtain access to the multitenant system. The tenants may also be multiple applications competing for shared underlying resources. Multiple organizations can access the resources of the communication services platform 120 without any indication that the resources are shared between the multiple organizations. The data of each of the organizations can be logically isolated from one another such that each organization has access to their own data but not the data of other organizations in the multitenant system. In some implementations, the communication services platform 120 can include a single tenant system.

An organization can be an example of an entity, such as a legal entity. An example of an organization includes a corporation (e.g., authorized by law to act as a single entity or legal entity).

In some implementations, a “user” may be represented as a single individual. However, other implementations of the disclosure encompass a “user” being an entity controlled by a set of users and/or an automated source. For example, a set of individual users federated as one or more departments in an organization may be considered a “user.” In general, functions described in some implementations as being performed by the communication services platform 120 can also be performed on the client devices 110A through 110Z in other implementations (and vice versa), if appropriate. In addition, the functionality attributed to a particular component can be performed by different or multiple components operating together. The communication services platform 120 can also be accessed as a service provided to other systems or devices through appropriate APIs.

As noted above and in some implementations, a communication channel 114 can be implemented by software and/or hardware through which voice calls or messages can be sent to recipient devices (e.g., organizations different from communication services platform 120). In some implementations, the communication services offered by communication channels 114A-114Z can be integrated into the communication services platform 120. In some implementations, the communication services offered by the communication channels 114A-114Z can include voice communication services, messaging services, or other types of communication services. In some implementations, messaging services can include one or more of a SMS implemented by an SMS channel, a MMS offered by an MMS channel, or an IM service (e.g., chat messaging) offered by an IM service channel. In some implementations, communication channels 114A-114Z can also include a voice channel. For example, the voice channel may implement an application to send or receive voice calls. In another example, the voice channel may be implemented by a telecommunication service provider, such as PSTN provider, mobile communication services provider, and/or VOIP services provider.

In some implementations, an entity (e.g., organization) can be associated with an account (e.g., organizational account) of the communication services platform 120. Within the particular account of the organization, one or more user accounts of the communication services platform 120 may be associated with different users of the organization. In some implementations, the accounts are organized in a hierarchical structure where the organizational account is the root at the top of the hierarchy and the user accounts are nested under the organizational account. The communication services platform 120 may include an account management system 126. The account management system 126 may include hardware, software, or a combination of hardware and software configured to manage accounts of the communication services platform 120. Managing accounts may include functionality related to account creation, account deactivation, account suspension, account modification, or other functionality.

In some implementations, the communication services platform 120 can provision identifiers of communication endpoints to an organization's account and assign the identifiers to various user accounts associated with the organization. Such identifiers may include telephone numbers (e.g., 10-digit long code or short code). The assignment of identifiers can be flexible such that the assignment of an identifier can be one-to-one (e.g., one identifier to one user account) or one to many (e.g., one identifier to many user accounts).

In some implementations, the communication services platform 120 can dynamically assign or transfer the communication endpoint identifiers. For example, the platform 120 may initially assign identifier A to user account A. At a later time, the platform 120 may transfer and assign identifier A to another user account Z and unassign Identifier A from user account A. In some implementations, the platform 120 may assign a identifier to multiple user accounts.

In some implementations, the communication services platform 120 may include a non-compliant call detection system 128. The non-compliant call detection system 128 may include hardware, software, or a combination of hardware and software that obtains metrics for voice calls associated with an identifier (e.g., metrics for voice calls made by a communication endpoint associated with the identifier), determines whether the metrics indicate that the identifier has been used to make non-compliant voice calls, and cause the account management system 126 to perform mitigating or enforcing actions regarding an account associated with the identifier. Further details regarding the non-compliant call detection system 128 and the account management system 126 are provided below.

Although implementations of the disclosure are discussed in terms of communication service platforms, implementations may also be generally applied to any type of platform, system or service.

In situations in which the systems discussed here collect personal information about users, or may make use of personal information, the users may be provided with an opportunity to control whether the communication services platform 120 collects user information, or to control whether and/or how to receive content from the communication services platform 120 that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the communication services platform 120.

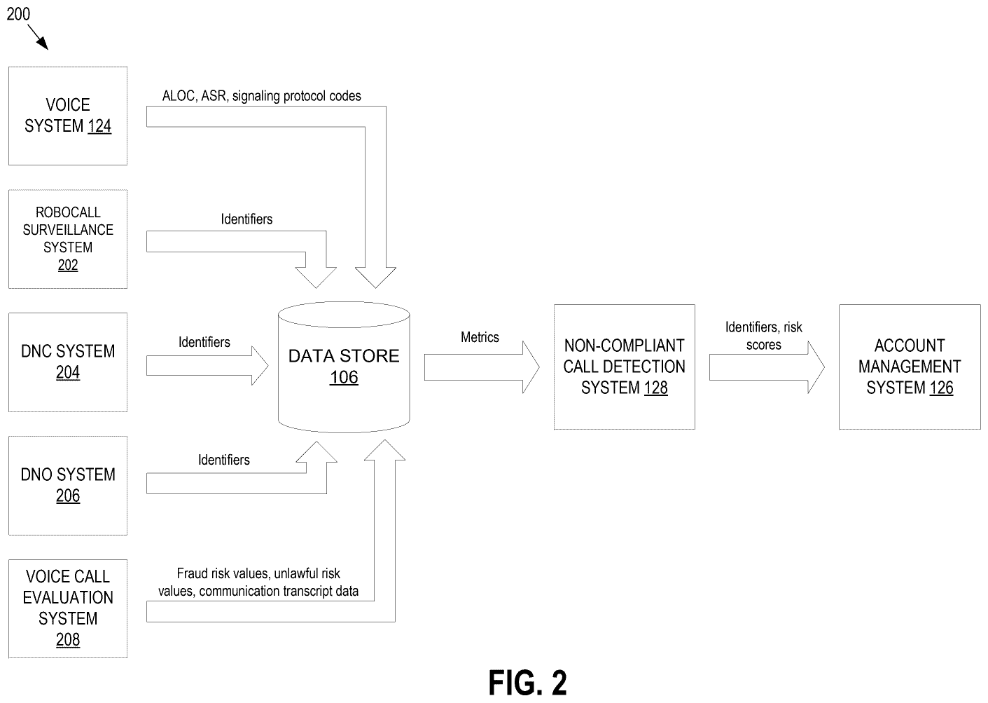

FIG. 2 illustrates an example flow of data 200 for identifying non-compliant communication services platform accounts, in accordance with some implementations of the disclosure. Some components of FIG. 1 are used to help describe aspects of FIG. 2. For example, the data flow 200 depicts the voice system 124, the data store 106, the non-compliant call detection system 128, and the account management system 126 of the system 100 of FIG. 1. The data flow 200 further depicts a robocall surveillance system 202, a DNC system 204, a do-not-originate (DNO) system 206, or a voice call evaluation system 208, which are discussed below.

In one implementation, the voice system 124 may provide metrics for voice calls to the data store 106 for storage in the data store 106. As discussed above in relation to FIG. 1, the voice system 124 may generate metadata for voice calls placed or received using the voice system 124. The voice calls may include voice calls associated with a communication endpoint identifier (e.g., a telephone number) that is assigned to an account of the communication services platform 120. The metadata for a voice call may include the identifier of the communication endpoint that received the voice call, the identifier of the communication endpoint that placed the voice call, the length of the call, whether the voice call was answered, signaling protocol codes associated with the voice call, or other voice call metadata.

In some implementations, the voice system 124 may generate metrics based on the metadata for the voice calls, and the voice system 124 may provide the metrics to the data store 106. In some implementations, the voice system 124 may provide the metadata to the data store 106, and the non-compliant call detection system 128 may generate the metrics based on the metadata.

The voice call metrics may include an average length of call (ALOC) (sometimes referred to as an “average call duration”) associated with a communication endpoint associated with a certain identifier. Calculating the ALOC may include dividing the total amount of time spent on voice calls by the number of voice calls made by the communication endpoint associated with the identifier. The ALOC may pertain to a specified time period (e.g., the previous 7, 14, or 30 days, a previous calendar month, or the like). A low ALOC (e.g., less than a predefined threshold duration) associated with a particular communications endpoint may indicate that the endpoint is used to make non-compliant calls, such as non-compliant voice calls.

The voice call metrics may include an answer-seizure ratio (ASR) associated with the identifier of a communication endpoint. The ASR may be the ratio of the number of calls made by the communications endpoint that were answered to the total number of calls made by the communications endpoint. The ASR may pertain to a specified time period (e.g., the previous 7, 14, or 30 days, a previous calendar month, or the like). A communication endpoint associated with a low ASR may indicate that the endpoint is used to make non-compliant voice calls.

The metrics may include a share of calls that produced one or more predetermined signaling protocol codes or that were otherwise associated with one or more predetermined signaling protocol codes. One example of a signaling protocol include SIP. A signaling protocol code may define the status of a communication request. For example, SIP code 404 can indicate that the recipient communication endpoint for a call cannot be found (e.g., because the calling communication endpoint called a telephone number that is not in use). SIP codes beginning with 6 (e.g., 600, 603, 604, etc.) can indicate that the recipient communication endpoint declines to participate in the call. For example, SIP code 603 can indicate that the recipient communication endpoint declined the call. SIP code 604 can indicate that the recipient communication endpoint does not exist. SIP code 606 can indicate that a characteristic of the call was not acceptable to the recipient communication endpoint. SIP 607 can indicate that the call is unwanted by the recipient communication endpoint. SIP code 608 can indicate that an intermediary device rejected the call.

In some implementations, the metrics may include a share of voice calls made by a particular communication endpoint where the voice calls received or produced a signaling protocol code indicating that the recipient communication endpoint could not be found (e.g., SIP code 404) or that the recipient communication endpoint declined the call (e.g., SIP codes beginning with 6). The share may pertain to a time period (e.g., the previous 7, 14, or 30 days, a previous calendar month, or the like). A communication endpoint associated with a high percentage of calls that received or produced such signaling protocol codes may indicate that the endpoint is used to make non-compliant voice calls.

In some implementations, the robocall surveillance system 202 may include a system that manages one or more communication endpoints that receive communications (e.g., voice calls) but do not initiate communications to other communication endpoints. Since endpoints managed by the robocall surveillance system 202 do not initiate communications, and since the entity that operates the robocall surveillance system 202 does not perform actions that would solicit communications to its endpoints, a record that a first communication endpoint communicated with a second communication endpoint managed by the robocall surveillance system 202 may indicate that the first endpoint is used to make non-compliant voice calls.

In some implementations, the communication services platform 120 may include the robocall surveillance system 202. In some implementations, the robocall surveillance system 202 may be hosted on a device, server, or platform that is external from the communication services platform 120. The robocall surveillance system 202 may be operated by an entity that is separate from the entity that operates the communication services platform 120. The communication services platform 120 may communicate with the robocall surveillance system 202 via an API and may cause the robocall surveillance system 202 to send metrics to the data store 106 for storage.

In some implementations, the metrics sent by the robocall surveillance system 202 to the data store 106 may include one or more identifiers of communication endpoints. The one or more identifiers may include identifiers associated with communication endpoints managed by the communication services platform 120 that communicated with one or more communication endpoints managed by the robocall surveillance system 202. The data may include a number of times a certain communication endpoint managed by the communication services platform 120 communicated with a communication endpoint managed by the robocall surveillance system 202.

In some implementations, the DNC system 204 may include a system that maintains a registry of one or more identifiers that appear on a DNC list. A DNC list may include a list of identifiers for communication endpoints whose owners or operators have requested that the communication endpoints not be contacted by unsolicited communications. A record that a first communication endpoint placed a voice call to a second communication endpoint associated with an identifier that is included in the DNC list may indicate that the first communication endpoint is used to make non-compliant voice calls. The DNC system 204 may provide at least a portion of the identifiers included in the DNC list to the data store 106.

In some implementations, the DNO system 206 may include a system that maintains a registry of one or more identifiers that appear on a DNO list. A DNO list may include a list of identifiers for communication endpoints that only receive communications and do not initiate communications. Identifiers that are included in a DNO list may include official telephone numbers for government agencies, business customer service telephone numbers, or the like. If the identifier of a communication endpoint that is managed by the communication services platform 120 matches an identifier included in a DNO list, this can indicate that the communication endpoint is spoofing another identifier and may be used to make non-compliant voice calls. The DNO system 206 may provide at least a portion of the identifiers included in the DNO list to the data store 106.

In some implementations, the DNC system 204 and/or the DNO system 206 may be hosted on a device, server, or platform that is external from the communication services platform 120. The DNC system 204 and/or the DNO system 206 may be operated by an entity that is separate from the entity that operates the communication services platform 120. The communication services platform 120 may communicate with the DNC system 204 and/or the DNO system 206 via an API and may cause the DNC system 204 and/or the DNO system 206 to send data to the data store 106 for storage.

The voice call evaluation system 208 may include a system that manages one or more communication endpoints that receive communications (e.g., voice calls) from other communication endpoints, evaluates the contents of the communications, and calculates one or more risk value indicative of whether the identifier is used to initiate non-compliant communications. In some implementations, the voice call evaluation system 208 may be hosted on a device, server, or platform that is external from the communication services platform 120. The voice call evaluation system 208 may be operated by an entity that is separate from the entity that operates the communication services platform 120. The communication services platform 120 may communicate with the voice call evaluation system 208 via an API and may cause the voice call evaluation system 208 to send metrics to the data store 106 for storage.

The voice call metrics produced by the voice call evaluation system 208 may include a fraud risk value associated with an identifier for a communication endpoint managed by the platform 120. The fraud risk value may include a value indicating a likelihood that the communication endpoint associated with the identifier is used to initiate fraudulent communications. The voice call evaluation system 208 may calculate the fraud risk score based on the contents of one or more voice communications from the communication endpoint. Content of a voice communication that can indicate fraud may include impersonating a entity (a financial institute, a retailer, a government agency, etc.), attempting to gather personal information, or engaging in other fraudulent communications. In one example, the fraud risk value may include a value between 0 and 1 where values closer to 0 indicate that the communication endpoint is not likely used to initiate fraudulent communications, and values closer to 1 indicate that the communication endpoint is likely used to initiate fraudulent communications.

The voice call metrics from the voice call evaluation system 208 may include an unlawful risk value associated with an identifier for a communication endpoint managed by the platform 120. The unlawful risk value may include a value indicating a likelihood that the identifier is used to initiate unlawful communications (other than fraudulent communications). The voice call evaluation system 208 may calculate the unlawful risk score based on the contents of one or more voice communications from the communication endpoint. Content of a voice communication that can indicate unlawful communications may include offering a product or service that is illegal or failing to comply with applicable telecommunication or telemarketing laws or regulations. For example, the unlawful risk value may include a value between 0 and 1 where values closer to 0 indicate that the communication endpoint is not likely used to initiate unlawful communications, and values closer to 1 indicate that the communication endpoint is likely used to initiate unlawful communications.

The voice call metrics from the voice call evaluation system 208 may include communication transcript data. Communication transcript data may include a transcript of a communication between a communication endpoint associated with an identifier managed by the communication services platform 120 and a communication endpoint managed by the voice call evaluation system 208. The communication transcript data may include a summary of the transcript of the communication. The communication transcript data may include an identifier of a category of the subject matter of the communication. The category may include brand impersonation (e.g., the identifier falsely claims that it is associated with a brand, business, or other entity), fraud, lead generation (e.g., the identifier attempts to cultivate potential customers for a product or service), or the like.

In some implementations, the non-compliant call detection system 128 may send a request to the data store 106 for at least a portion of the voice call metrics stored by the data store 106. The non-compliant call detection system 128 may determine, based on the voice call metrics, a risk score associated with the communication endpoint. The risk score indicates a likelihood of the communication endpoint being used to initiate non-compliant calls. In some implementations, the risk score may be a binary value. In some implementations, the risk score may include a real value between 0 and 1 where values closer to 0 indicate that the identifier is not likely used to initiate non-compliant voice calls, and values closer to 1 indicate that the identifier is likely used to initiate non-compliant voice calls.

In some implementations, the non-compliant call detection system 128 may store one or more threshold values associated with one or more respective voice call metrics. If a certain voice call metric associated with a communication endpoint exceed the threshold value for that certain voice call metric, the non-compliant call detection system 128 may set or modify the risk score. The threshold values for the voice call metrics may be set by an administrator of the communication services platform 120.

The non-compliant call detection system 128 may store a threshold value for the ALOC voice call metric. Responsive to the ALOC for a communication endpoint exceeding the threshold ALOC value, the non-compliant call detection system 128 may set or increase the risk score associated with the communication endpoint.

The non-compliant call detection system 128 may store a threshold value for the ASR voice call metric. Responsive to the ASR for a communication endpoint being below the threshold ASR value, the non-compliant call detection system 128 may set or increase the risk score associated with the communication endpoint.

The non-compliant call detection system 128 may store a threshold value for the signaling protocol codes voice metric. Responsive to the portion of voice calls placed by the communication endpoint that are associated with one or more predetermined signaling protocol codes exceeding the threshold value, the non-compliant call detection system 128 may set or increase the risk score associated with the communication endpoint.

The non-compliant call detection system 128 may store a threshold value for the voice call metric for the number of communications initiated by the communication endpoint to a communication endpoint managed by the robocall surveillance system 202. The non-compliant call detection system 128 may store a threshold value for the voice call metric for the number of communications initiated by the communication endpoint to a communication endpoint associated with an identifier on a DNC list.

The non-compliant call detection system 128 may store a threshold value associated with a fraud risk value provided by the voice call evaluation system 208. As discussed above, the fraud risk value may include a value indicating a likelihood that the communication endpoint is used to initiate fraudulent communications (e.g., a real value between 0 and 1 where values closer to 0 indicate that the communication endpoint is not likely used to initiate fraudulent communications, and values closer to 1 indicate that the communication endpoint is likely used to initiate fraudulent communications).

The non-compliant call detection system 128 may store a threshold value associated with an unlawful risk value provided by the voice call evaluation system 208. As discussed above, the unlawful risk value may include a value indicating a likelihood that the communication endpoint is used to initiate unlawful communications (e.g., a real value between 0 and 1 where values closer to 0 indicate that the communication endpoint is not likely used to initiate unlawful communications, and values closer to 1 indicate that the communication endpoint is likely used to initiate unlawful communications).

The non-compliant call detection system 128 may include a threshold value associated with communication transcript data. As discussed above, communication transcript data may include data indicating a category of the subject matter of a communication initiated by the communication endpoint (e.g., brand impersonation, fraud, lead generation, etc.). The threshold value associated with the communication transcript data may include a number of communications from the communication endpoint categorized under one or more predetermined categories.

In some implementations, the non-compliant call detection system 128 may determine whether one or more voice call metrics associated with the communication endpoint exceed a respective threshold value for a metric. Responsive to a metric exceeding the associated threshold value, the non-compliant call detection system 128 may set or modify a risk score associated with the communication endpoint.

In some implementations, the risk score may include a value. Responsive to determining that a voice metric associated with the communication endpoint exceeds the voice call metric's associated threshold value, the non-compliant call detection system 128 may increase the value of the risk score. The non-compliant call detection system 128 metric may increment the risk score by a predetermined increment value if the voice call metric is found to exceed the associated threshold value. The predetermined amount may be based on the specific voice call metric. For example, in response to the ALOC metric exceeding the ALOC threshold value, the non-compliant call detection system 128 may increase the risk score by a first amount, and in response to the fraud score exceeding the fraud score threshold value, the non-compliant call detection system 128 may increase the risk score by a second amount, and the second amount may be greater than the first amount. A predetermined amount may be configured by an administrator of the communication services platform 120.

In some implementations, the risk score may include one or more sub-scores. A sub-score may be associated with one or more metrics. In response to a metric associated with a sub-score exceeding the associated threshold value, the non-compliant call detection system 128 may increase the sub-score.

In some implementations, the risk score may include a proportion of the metrics that exceed their respective threshold values. The risk score may include a number of metrics that exceed their respective threshold values. The risk score may include a list of metrics that exceed their respective threshold values.

In some implementations, multiple communication endpoints may be associated with an account of the communication services platform 120. The non-compliant call detection system 128 may determine risk scores for multiple communication endpoints that are associated with a single account. The non-compliant call detection system 128 may determine, based on the risk scores, a risk score associated with the account.

In one implementation, the non-compliant call detection system 128 may use a rules engine to determine the risk score for an identifier or for an account. The rules engine may use, as input, one or more metrics associated with the identifier or the account. The rules engine may determine the risk score based on the rules and logic of the rules engine. An administrator of the communication services platform 120 may configure the rules and logic of the rules engine.

In some implementations, the non-compliant call detection system 128 may utilize an artificial intelligence (AI)-based model to determine the risk score. The AI model (e.g., implemented by one or more neural networks) may include an AI model trained to calculate the risk score based on the one or more voice call metrics associated with the identifier(s) or the account associated with the identifier(s). The AI model may use one or more of the voice metrics as input and may output the risk score.

The non-compliant call detection system 128 may provide one or more identifiers for communication endpoints and one or more risk scores associated with the communication endpoints to the account management system 126. The account management system 126 may perform, based on one or more risk scores, a corrective action with respect to an account associated with an identifier.

A corrective action may include suspending the account associated with the identifier. Suspending the account may include preventing a user of the account from performing functionality on the communication services platform 120. The corrective action may include disabling use of the identifier with the associated communication endpoint on the platform 120. Disabling use of the identifier may include preventing the account from using the communication endpoint associated with the identifier to initiate communications using the conversations system 122 or the voice system 124, receive communications, or otherwise use the communication endpoint to communicate with other communication endpoints.

The corrective action may include providing a notification to a user associated with the account that is associated with the identifier. The notification may include an email, text message, voice communication, or message on an internal message service of the platform 120. The notification may include a message notifying the user that the communication endpoint is possibly being used to make non-compliant voice calls. The notification may include a message notifying the user that use of the identifier associated with the communication endpoint may be disabled if the user does not take action to prevent further non-compliant voice calls. The notification may include a message notifying the user that the account may be suspending if the user does not take action to prevent further non-compliant voice calls.

In some implementations, the account management system 126 may select the corrective action based on the risk score that the non-compliant call detection system 128 determined for the communication endpoint. In some implementations, the account management system 126 may select the corrective action based on one or more characteristics of the account on the communication services platform 120 associated with the identifier. A characteristic of the account can include a characteristic of the user of the account. A characteristic of the account may include a size of the user (e.g., an employee count; a number of identifiers associated with the account; or where the account is an organizational account, the number of accounts associated with the organizational account). A characteristic of the account may include a revenue of the user of the account. A characteristic may include a level of importance of the account (e.g., a value assigned to the account by the communication services platform 120). A characteristic may include a communications traffic profile of the account (e.g., a number of communications initiated by communication endpoints for identifiers associated with the account, a number of communications received by the communication endpoints, or other communications traffic metrics). The account management system 126 selecting the corrective action based on one or more characteristics of the account may include selecting the corrective action based on a characteristic exceeding a threshold value for the characteristic.

In some implementations, the account management system 126 may use a rules engine to select the corrective action. The rules engine may use, as input, the risk score and/or the one or more characteristics of the account. The rules engine may select the corrective action based on the rules and logic of the rules engine. An administrator of the communication services platform 120 may configure the rules and logic of the rules engine.

In some implementations, where the risk score includes a value, the rules may select the corrective action based on the risk score exceeding a predetermined threshold value. For example, where the risk score can include a value between 0 and 1, the rules engine may select, as the corrective action, (1) notifying the user responsive to the risk score being between 0.5 and 0.69; (2) disabling use of the identifier responsive to the risk score being between 0.7 and 0.89; and (3) suspending the account on the platform 120 that is associated with the identifier responsive to the risk score being 0.9 or greater.

In some implementations, where the risk score includes one or more sub-scores, the rules engine may select the corrective action based on the one or more risk scores exceeding predetermined threshold values. The account management system 126 may select the corrective action based on different combinations of sub-scores.

In one example, the risk score may include three sub-scores: a first sub-score associated with the voice call metrics provided by the voice system 124, a second sub-score associated with the voice call metrics provided by the robocall surveillance system 202, and a third sub-second associated with the voice call metrics provided by the voice call evaluation system 208. Responsive to none of the sub-scores exceeding the threshold value associated with the respective sub-score, the rules engine may select taking no action as the corrective action. Responsive to one of the sub-scores exceeding the threshold value associated with the respective sub-score, the rules engine may select sending a notification as the corrective action. Responsive to two of the sub-scores exceeding their respective threshold values, the rules engine may select disabling the identifier as the corrective action. Responsive to all three sub-scores exceeding their respective threshold values, the rules engine may select suspending the account as the corrective action.

In other example, responsive to the first sub-score being below a threshold value for the first sub-score, the corrective action may include the account management system 126 taking no action regarding the identifier, regardless of the second and third sub-scores. Responsive to the first sub-score and the second sub-score exceeding their respective threshold values, the corrective action may include the account management system 126 sending a notification to the user associate with the account associated with the identifier. Responsive to the first sub-score and the third sub-score exceeding their respective threshold values, the corrective action may include the account management system 126 disabling use of the identifier. Responsive to all three sub-scores exceeding their respective threshold values, the account management system 126 may select suspending the account as the corrective action.

In some implementations, the rules engine may modify a corrective action the rules engine selected based on the risk score. For example, as discussed above, based on the risk score associated with an identifier that is associated with the account, the rules engine may initially select disabling the identifier as the corrective action. The rules engine may modify the corrective action to be sending a notification to the user of the account based on the size of the account exceeding a threshold size.

As discussed above, in some implementations, multiple identifiers may be associated with an account of the communication services platform 120, and the non-compliant call detection system 128 may determine risk scores for multiple identifiers that are associated with a single account. Selecting the corrective action may include the rules engine selecting the corrective action based on a predetermined number or portion of risk scores associated with the identifiers exceeding a threshold risk score. The predetermined number may include 1, 2, 3, 4, 5, or some other number. The predetermined portion may include a majority of the risks scores. The predetermined portion may include at least 40%, at least 50%, at least 60%, at least 70%, or some other percentage of the risk scores.

As an example, responsive to 1 or 2 risk scores exceeding the threshold risk score, the rules engine may select sending a notification as the corrective action. Responsive to 3 risk scores exceeding the threshold risk score, the rules engine may select disabling one or more identifiers associated with the account (e.g., the identifiers associated with risk scores that exceed the threshold risk score) as the corrective action. Responsive to 4 or more risk scores exceeding the threshold risk score, the rules engine may select suspending the account as the corrective action.

In another example, responsive to 20-50% of the identifiers exceeding the threshold risk score, the rules engine may select sending a notification as the corrective action. Responsive to 51-70% of the identifiers exceeding the threshold risk score, the rules engine may select disabling one or more identifiers associated with the account as the corrective action. Responsive to more than 70% of the identifiers exceeding the threshold risk score, the rules engine may select suspending the account as the corrective action.

In some implementations, the account management system 126 may utilize an AI-based model to select the corrective action. The AI model (e.g., implemented by one or more neural networks) may include an AI model trained to identify the most suitable corrective action corresponding to the risk score and/or the one or more characteristics of the account. The AI model may use one or more risks scores and account characteristics as input and may output the corrective action.

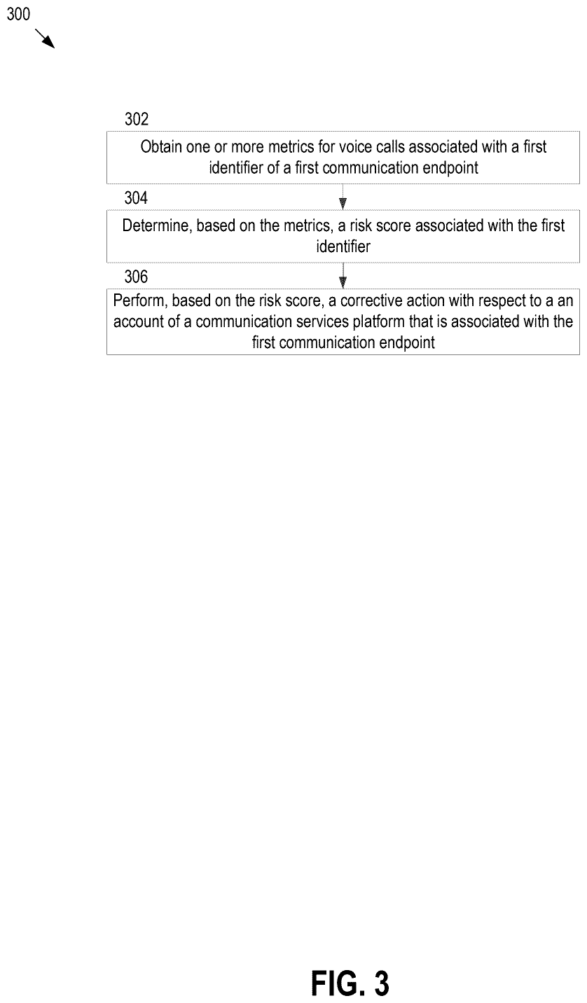

FIG. 3 depicts a flow diagram of an example method 300 for identifying non-compliant communication services platform accounts, in accordance with some implementations of the disclosure. In some implementations, method 300 can be performed by the communication services platform 120, and in particular, the non-compliant call detection system 128 and/or the account management system 126 of the communication services platform 120.

The method 300 of FIG. 3 and/or each of the method's 300 individual functions, routines, subroutines, or operations can be performed by a processing device, having one or more processing units (CPU) and memory devices communicatively coupled to the CPU(s). In some implementations, the method 300 can be performed by a single processing thread or alternatively by two or more processing threads, each thread executing one or more individual functions, routines, subroutines, or operations of the method. The method 300, as described below, can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the operations of the method 300 can be modified. Thus, the illustrated implementations should be understood only as examples, and the illustrated operations can be performed in a different order, while some operations can be performed in parallel. Additionally, one or more operations can be omitted. In some implementations. Thus, not all illustrated operations are required in every implementation, and other process flows are possible. In some implementations, the same, different, fewer, or greater operations can be performed. It may be noted that elements of FIG. 1-2 may be used herein to help describe FIG. 3.

At operation 302, processing logic obtains, by the communication services platform 120, one or more metrics for voice calls associated with a first identifier of a first communication endpoint. In some implementations, the first identifier of the first communication endpoint may include a telephone number.

In some implementations, the one or more voice call metrics may include an average call duration for the first identifier. The one or more voice call metrics may include one or more predetermined signaling protocol codes. The one or more voice call metrics may include an ASR associated with the first identifier.

In some implementations, the one or more voice call metrics may include a record of a communication initiated by the first communication endpoint to a predefined second communication endpoint. The second communication endpoint may be restricted from initiating communications (e.g., a communication endpoint managed by a robocall surveillance system 202). The second communication endpoint may be associated with an identifier included in a DNC list of the DNC system 204. The one or more metrics may include a record that the first identifier is included in a DNO identifier list of the DNO system 206. The one or more voice call metrics may include a fraud risk value associated with the first identifier, an unlawful risk value associated with the first identifier, or communication transcript data associated with the first identifier (e.g., voice call metrics received from the voice call evaluation system 208).

At operation 304, processing logic determines, based on the voice call metrics, a risk score associated with the first identifier. Determining the risk score may include the non-compliant call detection system 128 determining the risk score, as discussed above.

At operation 306, processing logic performs, based on the risk score, a responsive action with respect to an account of the communication services platform 120 associated with the first communication endpoint.

In some implementations, the responsive action may include suspending the account, disabling use of the first identifier on the communication services platform 120, or providing a notification to the owner of the account.

In some implementations, the method 300 further includes selecting the responsive action based on a characteristic of the account or based on the risk score. In some implementations, the method 300 further includes determining, based on one or more metrics for voice calls associated with a second identifier of a communication endpoint associated with the account, a risk score associated with the second identifier. Performing the responsive action (operation 406) may be further based on the risk score associated with the second identifier.

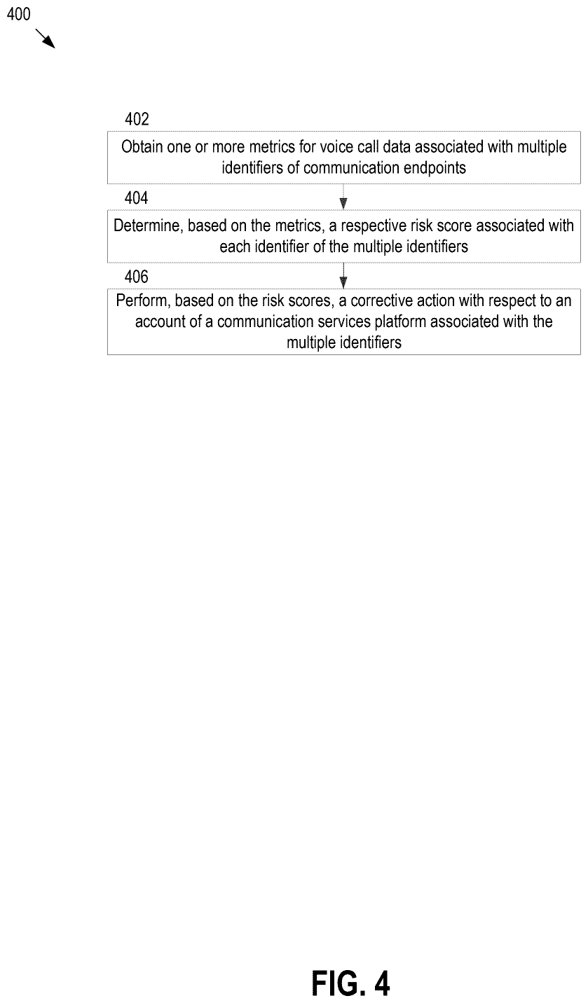

FIG. 4 depicts a flow diagram of another example method 400 for identifying non-compliant communication services platform accounts, in accordance with some implementations of the disclosure. In some implementations, method 400 can be performed by the communication services platform 120, and in particular, the non-compliant call detection system 128 and/or the account management system 126 of the communication services platform 120.

The method 400 of FIG. 4 and/or each of the method's 400 individual functions, routines, subroutines, or operations can be performed by a processing device, having one or more processing units (CPU) and memory devices communicatively coupled to the CPU(s). In some implementations, the method 400 can be performed by a single processing thread or alternatively by two or more processing threads, each thread executing one or more individual functions, routines, subroutines, or operations of the method. The method 400, as described below, can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the operations of the method 400 can be modified. Thus, the illustrated implementations should be understood only as examples, and the illustrated operations can be performed in a different order, while some operations can be performed in parallel. Additionally, one or more operations can be omitted. In some implementations. Thus, not all illustrated operations are required in every implementation, and other process flows are possible. In some implementations, the same, different, fewer, or greater operations can be performed. It may be noted that elements of FIG. 1-2 may be used herein to help describe FIG. 4.

At operation 402, processing logic obtains, by the communication services platform 120, one or more metrics for voice call data associated with multiple identifiers. Each identifier may be associated with a respective communication endpoint.

In some implementations, the one or more voice call metrics may include a respective average call duration associated with each identifier of the multiple identifiers. The one or more voice call metrics may include one or more predetermined signaling protocol codes. The one or more voice call metrics may include a respective ASR associated with each identifier of the multiple identifiers.

In some implementations, the one or more voice call metrics may include records of communications initiated by the communicate endpoints to a predefined second communication endpoint. The second communication endpoint may be restricted from initiating communications (e.g., a communication endpoint managed by the robocall surveillance system 202) or an identifier of a communication endpoint included in a DNC list of the DNC system 204. The one or more voice metrics may include records that the identifiers are included in a DNO list of the DNO system 206. The one or more voice call metrics may include a respective fraud risk value associated with each identifier of the multiple identifiers, an unlawful risk value associated with each identifier of the multiple identifiers, or communication transcript data associated with identifiers (e.g., voice call metrics received from the voice call evaluation system 208).

At operation 404, processing logic determines, based on the voice call metrics, respective risk scores associated with each identifier of the multiple identifiers. Determining the risk scores may include the non-compliant call detection system 128 determining the risk scores, as discussed above.

At operation 406, processing logic performs, based on the risk scores, a responsive action with respect to an account of the communication services platform associated with the multiple identifiers. In some implementations, the responsive action may include suspending the account, disabling use of one or more of the identifiers on the communication services platform 120, or providing a notification to the owner of the account.

In some implementations, the method 400 further includes selecting the responsive action based on a characteristic of the SaaS platform account or based on the risk scores.

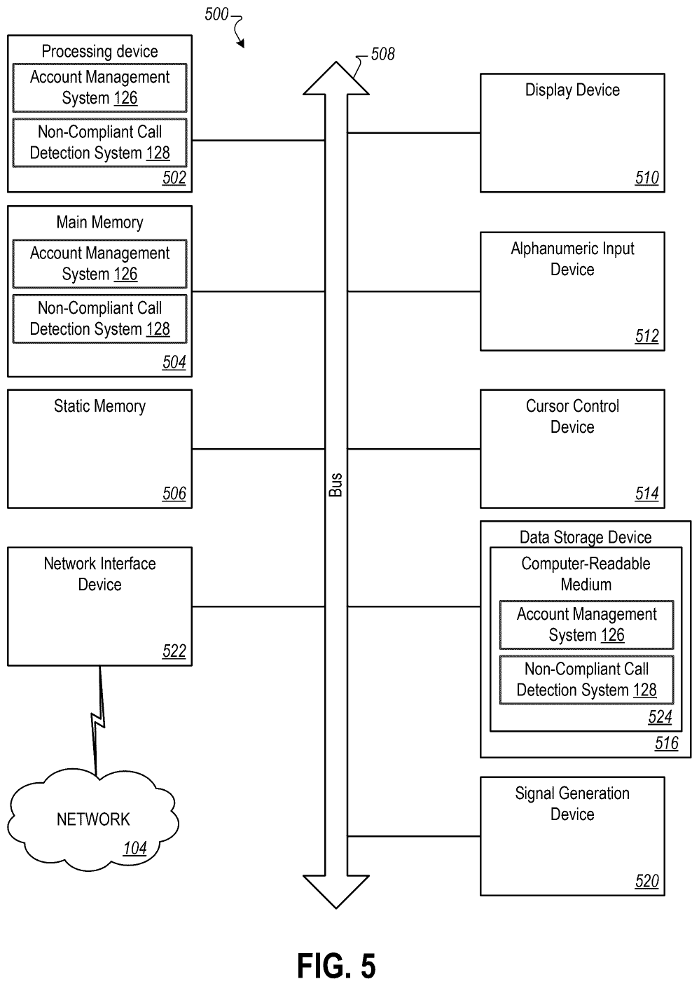

FIG. 5 is a block diagram illustrating an exemplary computer system 500, in accordance with an implementation of the disclosure. The computer system 500 executes one or more sets of instructions that cause the machine to perform any one or more of the methodologies discussed herein. Set of instructions, instructions, and the like may refer to instructions that, when executed by the computer system 500, cause the computer system 500 to perform one or more operations of the account management system 126 and/or the non-compliant call detection system 128. The machine may operate in the capacity of a server or a client device in a client-server network environment, or as a peer machine in a peer-to-peer (or distributed) network environment. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions to perform any one or more of the methodologies discussed herein.

The computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 516, which communicate with each other via a bus 508.

The processing device 502 represents one or more general-purpose processing devices such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute instructions of the system architecture 100 and the account management system 126 and/or the non-compliant call detection system 128 for performing the operations discussed herein.

The computer system 500 may further include a network interface device 522 that provides communication with other machines over the network 104, such as a local area network (LAN), an intranet, an extranet, or the Internet. The computer system 500 also may include a display device 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker).

The data storage device 516 may include a non-transitory computer-readable storage medium 524 on which is stored the sets of instructions of the system architecture 100 of the account management system 126 and/or the non-compliant call detection system 128 embodying any one or more of the methodologies or functions described herein. The sets of instructions of the system architecture 100 and of the account management system 126 and/or the non-compliant call detection system 128 may also reside, completely or at least partially, within the main memory 504 and/or within the processing device 502 during execution thereof by the computer system 500, the main memory 504 and the processing device 502 also constituting computer-readable storage media. The sets of instructions may further be transmitted or received over the network 518 via the network interface device 522.

While the example of the computer-readable storage medium 524 is shown as a single medium, the term “computer-readable storage medium” can include a single medium or multiple media (e.g., a centralized or distributed database, and/or associated caches and servers) that store the sets of instructions. The term “computer-readable storage medium” can include any medium that is capable of storing, encoding or carrying a set of instructions for execution by the machine and that causes the machine to perform any one or more of the methodologies of the disclosure. The term “computer-readable storage medium” can include, but not be limited to, solid-state memories, optical media, and magnetic media.

In the foregoing description, numerous details are set forth. It will be apparent, however, to one of ordinary skill in the art having the benefit of this disclosure, that the disclosure may be practiced without these specific details. In some instances, well-known structures and devices are shown in block diagram form, rather than in detail, in order to avoid obscuring the disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It may be borne in mind, however, that all of these and similar terms are to be associated with the appropriate physical quantities and are merely convenient labels applied to these quantities. Unless specifically stated otherwise, it is appreciated that throughout the description, discussions utilizing terms such as “obtaining,” “determining,” “performing,” “suspending,” “disabling,” “providing,” “calculating,” “sending,” “receiving,” “notifying” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an embodiment” or “one embodiment” throughout is not intended to mean the same implementation or embodiment unless described as such. The terms “first,” “second,” “third,” “fourth,” etc. as used herein are meant as labels to distinguish among different elements and may not necessarily have an ordinal meaning according to their numerical designation.

For simplicity of explanation, methods herein are depicted and described as a series of acts or operations. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional embodiments, one or more processing devices for performing the operations of the above-described embodiments are disclosed. Additionally, in embodiments of the disclosure, a non-transitory computer-readable storage medium stores instructions for performing the operations of the described embodiments. Also in other embodiments, systems for performing the operations of the described embodiments are also disclosed.

It is to be understood that the above description is intended to be illustrative, and not restrictive. Other embodiments will be apparent to those of skill in the art upon reading and understanding the above description. The scope of the disclosure may, therefore, be determined with reference to the appended claims, along with the full scope of equivalents to which such claims are entitled.

What is claimed is:

1. A method, comprising:
obtaining, by a communication services platform, a plurality of metrics for voice calls associated with an identifier of a first communication endpoint, wherein the plurality of metrics comprises at least one of:
an average call duration for the first identifier, or
a predetermined signaling protocol code;
determining, based on the metrics, a risk score associated with the first identifier; and
performing, based on the risk score, a corrective action with respect to an account of the communication services platform, wherein the account is associated with the first communication endpoint.

2. The method of claim 1, wherein the first identifier of the communication endpoint comprises a telephone number.

3. The method of claim 1, wherein the plurality of metrics for the voice calls comprises an answer-seizure ratio associated with the first identifier.

4. The method of claim 1, wherein the plurality of metrics for the voice calls comprises a record of a communication initiated by the first communication endpoint to a predefined second communication endpoint.

5. The method of claim 4, wherein the second communication endpoint is restricted from initiating communications.

6. The method of claim 1, wherein the plurality of metrics for the voice calls comprises a record indicating that the first identifier is included in a do-not-originate identifier list.

7. The method of claim 1, wherein the corrective action comprises at least one of:
suspending the account;
disabling use of the first identifier on the communication services platform; or
providing a notification to an owner of the account.

8. The method of claim 1, further comprising selecting the corrective action based on at least one of:
a characteristic of the SaaS platform account; or
the risk score.

9. The method of claim 1, wherein:
the method further comprises determining, based on a plurality of metrics for voice calls associated with an identifier of a second communication endpoint associated with the SaaS platform account, a risk score associated with the second identifier; and
performing the corrective action on the SaaS platform account is further based on the risk score associated with the second identifier.

10. A system, comprising:
a memory; and
a processing device, coupled to the memory, to perform operations comprising:
obtaining, by a communication services platform, a plurality of metrics for voice calls associated with a first identifier of a first communication endpoint, wherein the plurality of metrics comprises at least one of:
an average call duration for the first identifier, or
a predetermined signaling protocol code;
determining, based on the metrics, a risk score associated with the first identifier; and
performing, based on the risk score, a corrective action with respect to an account of the first communication endpoint.

11. The system of claim 10, wherein the first identifier of the communication endpoint comprises a telephone number.

12. The system of claim 10, wherein the plurality of metrics for the voice calls comprises an answer-seizure ratio associated with the first identifier.

13. The system of claim 10, wherein the plurality of metrics for the voice calls comprises a record of a communication initiated by the first communication endpoint to a predefined second communication endpoint.

14. The system of claim 13, wherein the second communication endpoint is restricted from initiating communications.

15. The system of claim 10, wherein the plurality of metrics for the voice calls comprises a record that the first identifier is included in a do-not-originate identifier list.

16. The system of claim 10, wherein the corrective action comprises at least one of:
suspending the account;
disabling use of the first identifier on the communication services platform; or
providing a notification to an owner of the account.

17. The system of claim 10, wherein the operations further comprise selecting the corrective action based on a characteristic of the account.

18. A method, comprising:
obtaining, by a communication services platform, a plurality of metrics for voice calls associated with a plurality of identifiers, wherein each identifier of the plurality of identifiers is associated with a respective communication endpoint of a plurality of communication endpoints, and wherein the plurality of metrics comprises at least one of:
an average call duration for each identifier of the plurality of identifiers, or
a predetermined signaling protocol code associated with an identifier of the plurality of identifiers;
determining, based on the metrics, a respective risk score associated with each identifier of the plurality of identifiers; and
performing, based on the risk scores, a corrective action with respect to an account of the communication services platform, wherein the account is associated with the plurality of identifiers.

19. The method of claim 18, wherein performing the corrective action based on the risk scores comprises performing the corrective action in response to a predetermined number of risk scores exceeding a threshold risk score.

20. The method of claim 18, wherein the plurality of metrics for the voice calls comprises a record of a communication initiated by a first communication endpoint of the plurality of communication endpoints to a predefined second communication endpoint, wherein the predefined second communication endpoint is restricted from initiating communications.
